(19) United States
(12) Patent Application Publication
(10) Pub. No.: US 2011/0010866 A1
(43) Pub. Date: Jan. 20, 2011

(54) MULTI-PURPOSE UTILITY TOOL FOR HOCKEY EQUIPMENT

(76) Inventors: WILLIAM R. GREEN, Oak Park, IL (US); SCOTT R. STRONG, OakVille (CA); MICHAEL D. KLINCK, OakVille (CA)

Correspondence Address: J. GORDON THOMSON, P.O. BOX 8865, VICTORIA, BC, V8V 3Z1, CA

(21) Appl. No.: 12/505,512

(22) Filed: Jul. 19, 2009

(51) Int. Cl. B26B 11/00

(52) U.S. Cl. 7/118

(57) ABSTRACT

A multi-purpose utility tool for hockey equipment includes a handle and a plurality of devices pivotally attached to the tool by a plurality of pivot pins. Each device has a storage position within the handle. The tool comprises the following devices: a combination flat screw driving blade and bottle opener; a lace pulling tool; a lanyard mount; a scissor; a pliers; a screwing tool; a pick; and, tweezers.

### FIELD OF THE INVENTION

This invention relates to multi-purpose utility tools comprising a plurality of useful devices in a single unit, and more particularly, this invention relates to a multi-purpose utility tool designed for use on hockey equipment.

### BACKGROUND OF THE INVENTION

Multi-purpose utility tools are known. For example, jack knives comprise cutting blades and screwdriver blades. Wine tools comprise corkscrews, bottle openers and cutting blades. Golf tools comprise devices for cleaning shoe cleats and marking golf balls on putting greens. However, these tools are not well suited to those who play hockey and who wear the equipment associated with that game. Therefore, there is a need for a multi-purpose utility tool for hockey equipment with useful devices that can be used to maintain and adjust such equipment as skates, pads, helmets and taped sticks.

### SUMMARY OF THE INVENTION

Our invention is a multi-purpose utility tool for hockey equipment. The tool includes a plurality of useful devices for adjusting and maintaining hockey equipment. The tool includes a handle and all of the devices are stored within the handle. Each device pivots to working position from the handle. The devices include scissors for cutting tape, screwdrivers for adjusting screws on skates and helmets, a lace pulling tool and pliers.

### BRIEF DESCRIPTION OF THE DRAWINGS

FIG. 1 comprises eight views, A to H, of one embodiment of the invention, wherein:

FIG. 1A is a top view of the invention;

FIG. 1B is a first end view of the invention;

FIG. 1C is right side view of the invention;

FIG. 1D is a second end view of the invention;

FIG. 1E is a bottom view of the invention;

FIG. 1F is a left side view of the invention;

FIG. 1G is a perspective top view of the right side of the invention; and,

FIG. 1H is a perspective top view of the left side of the invention.

FIG. 2 is an exploded view of the invention showing internal arrangement.

FIG. 3 comprises seven views, A to G, of the invention with individual devices deployed; wherein:

FIG. 3A is a top perspective view showing a blade-type screwdriver combination bottle opener deployed;

FIG. 3B is a top perspective view showing scissors deployed;

FIG. 3C is a top perspective view showing pliers deployed;

FIG. 3D is a top perspective view showing a picking tool deployed;

FIG. 3E is a top perspective view showing a screwing tool deployed;

FIG. 3F is a top perspective view showing a lace pulling tool deployed; and,

FIG. 3G is a top perspective view showing tweezers deployed.

FIG. 4A is a top perspective first end view of the invention showing the positional relationship between a plurality of devices.

FIG. 4B is a top perspective second end view of the invention showing the positional relationship between a plurality of devices.

### DETAILED DESCRIPTION OF THE INVENTION

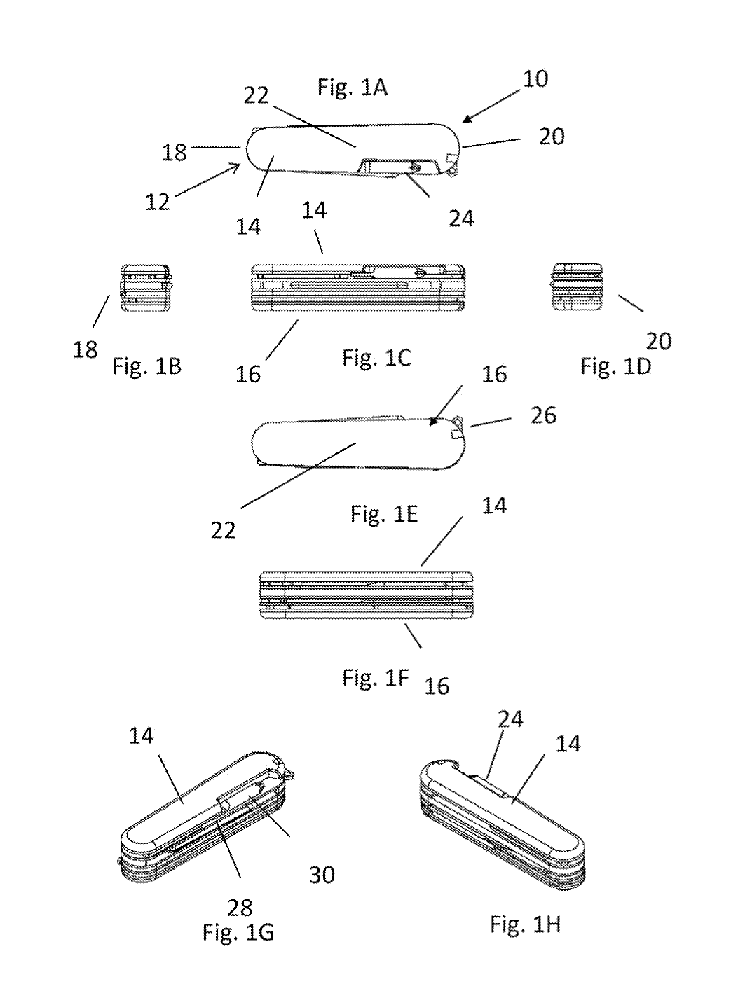

Referring to FIG. 1 A to H, the invention 10 is a multi-purpose utility tool for hockey equipment. The tool comprises a handle 12 comprising a handle first side piece 14 and a handle second side piece 16. The handle 12 has a first end 18 and a second end 20. In the embodiment shown the handle second end 20 is wider than the handle first end 18. The handle also has a centre point 22. As illustrated in FIG. 1, there are a plurality of devices, such as screwing tool 24 and lanyard attachment 26 stored between the handle first side piece 14 and the handle second side piece 16. These devices are pivotally attached to the tool by a plurality of pivot pins disposed between the handle first end 18 and the handle second 20 end and between the handle first side piece 14 and the opposite handle second side piece 16. As further explained below, each devices has a device mounting end 28 adapted for mounting on one of the pivot pins and a device working end 30 for working on a work piece such as a skate, helmet or lace.

It can be seen from FIG. 1 that each device working (for example 30) end has a storage position within the handle 12 and disposed between the handle first side piece 14 and the handle opposite handle second side piece 16. As further explained and illustrated below, the device working end 30 has a working position pivotally extended outwards from the handle 12.

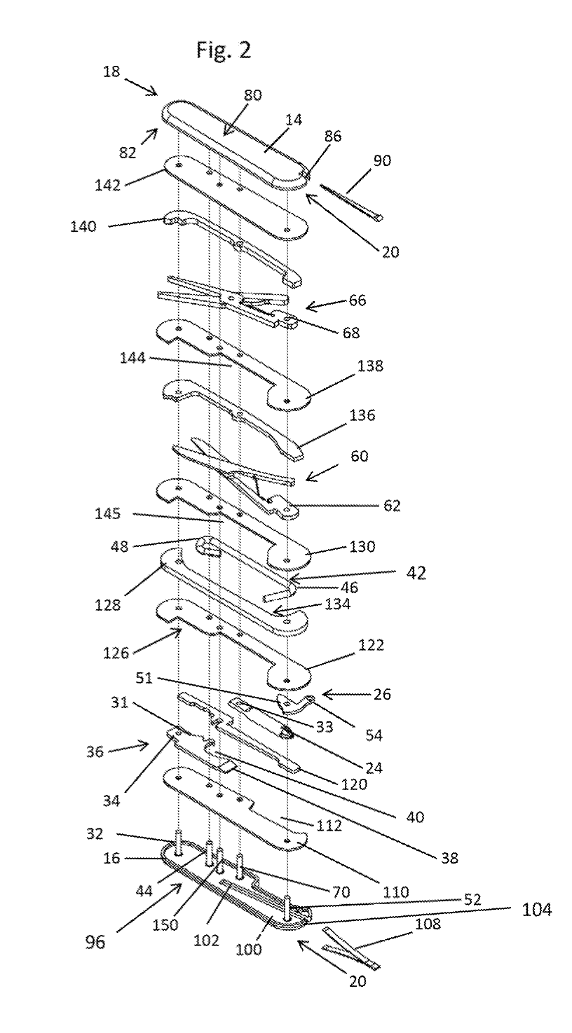

Referring now to FIG. 2, there is shown an exploded diagram of one embodiment of the invention 10. The hockey tool has a plurality of useful devices stored between the handle first side piece 14 and the handle second side piece 16. There is a first device 31 pivotally attached to the handle first end 18 by a first pivot pin 32. The first pivot pin 32 is disposed between the handle first end 18 and the handle second end 20 and it is proximate to the handle first end. The first device 31 includes an aperture 34 at the pivoting end 36 of the device for pivot mounting on pin 32. As illustrated, the working end of the device comprises a combination flat screw driving blade 38 and bottle opener 40. However, there could be another useful device mounted at that location instead of device 31.

Still referring to FIG. 2, the hockey tool includes a second device 42 pivotally attached to the handle 12 by a second pivot pin 44. Second pivot pin 44 is disposed between the first pivot pin 32 and the handle second end 20 proximate and adjacent to the first pivot pin. In the embodiment shown device 42 is a lace pulling tool. The lace pulling tool has a working end 46 for engaging a skate lace and a pivoting end 48 which is a loop for mounting over pivot pin 44.

Still referring to FIG. 2, the tool 10 mounts a third device 26 pivotally attached by aperture 51 to the handle 12 by a third pivot pin 52. The third pivot pin 52 is disposed between the handle first end 18 and the handle second end 20 proximate and adjacent to the handle second end. In the illustration shown, the third device 50 is a lanyard mount suitable for a lanyard to be clipped or threaded through aperture 54 so that the tool can be worn around the neck or on a belt or pinned to a bag.

There is also a fourth device 60 pivotally attached by aperture 62 to the third pivot pin 52. In the embodiment shown, device 60 is a scissor which would be useful in cutting hockey tape, skate laces or cloth.

A fifth device 66 is also attached by aperture 68 pivotally to the third pivot pin 52. In the embodiment shown, the fifth device is pliers.

The tool 10 further includes a sixth device 24 which is pivotally mounted by aperture 33 to a fourth pivot pin 70 disposed between the handle first end 18 and the handle second end 20 and proximate to the handle centre point 22. In the embodiment shown the sixth device is a screwing tool exemplified by a Phillips head screwdriver.

Still referring to FIG. 2, the tool 10 handle first side piece 14 further comprises a top surface 80 and a bottom surface 82 which is not illustrated but is similar to the top surface 100 of the handle second side piece 16. The bottom surface 82 includes a first channel 84 disposed therein. The first channel 84 (similar to channel 102) exits the bottom surface at a first notch 86 in the handle first side piece second end 20. The first channel 84 is adapted to receive a seventh device 90 in a tight sliding relationship. In the embodiment illustrated, the seventh device is a pick which would be suitable for, as an example, picking at dirt lodged in skate laces.

FIG. 2 further illustrates the handle second side piece 16 further comprises a top surface 100 and a bottom surface 96. The top surface 100 includes a second channel 102 disposed therein. The second channel 102 exits the top surface 100 at a second notch 104 in the handle second side piece 16 second end 20. The second channel 102 is adapted to receive an eighth device 108 in a tight sliding relationship. In the embodiment shown the eighth device is tweezers.

Referring to FIG. 2, the tool 10 further comprising at least one separating member 110 disposed between adjacent devices. These members are contoured to form storage chambers for each device permitting storage of each device without interference from an adjacent device. The separating members further permit easy finger retrieval of each of devices. The members have at least one aperture for fitting over at least one of the plurality of pivot pins for flush alignment with the handle first side piece and the handle second side piece.

Member 110 separates device 108 from device 31 and also device 31 from the inside surface 100 of the handle second side piece 16. Contour 112 in member 110 permits flush storage of device 31 within the handle 12. Member 120 lies between device 31 and device 34 to separate them as well as to ensure that these devices are readily finger accessible by preventing their working ends (e.g. item 38) from dropping within the handle and out of reach. Device 26 lies between member 110 and member 122. Member 122 is contoured 126 for device 31 to permit easy finger access to device 31. Member 128 lies between member 122 and member 130 and is contoured 134 to accept device 42 in storage. Device 62 lies above member 130 and adjacent to member 136 to permit easy finger retrieval of device 62. Member 138 separates device 60 from device 66. Members 130 and 138 have similar contours 144 and 145 to permit flush storage of devices 60 and 66 with the handle as well as permit easy finger access to these devices. Member 140 lies adjacent to device 66 to form a suitable storage chamber for device 66. Member 142 is disposed above member 140 and separates device 66 from device 90 and the bottom surface 82 of the handle first side piece 14.

The plurality of pins include a fifth pin 150 disposed between the third pin 44 and the fourth pin 70 proximate to the handle centre point 22. The fifth pin, in combination with said first, second, third and fourth pins, is adapted for aligning the separating plates within the handle.

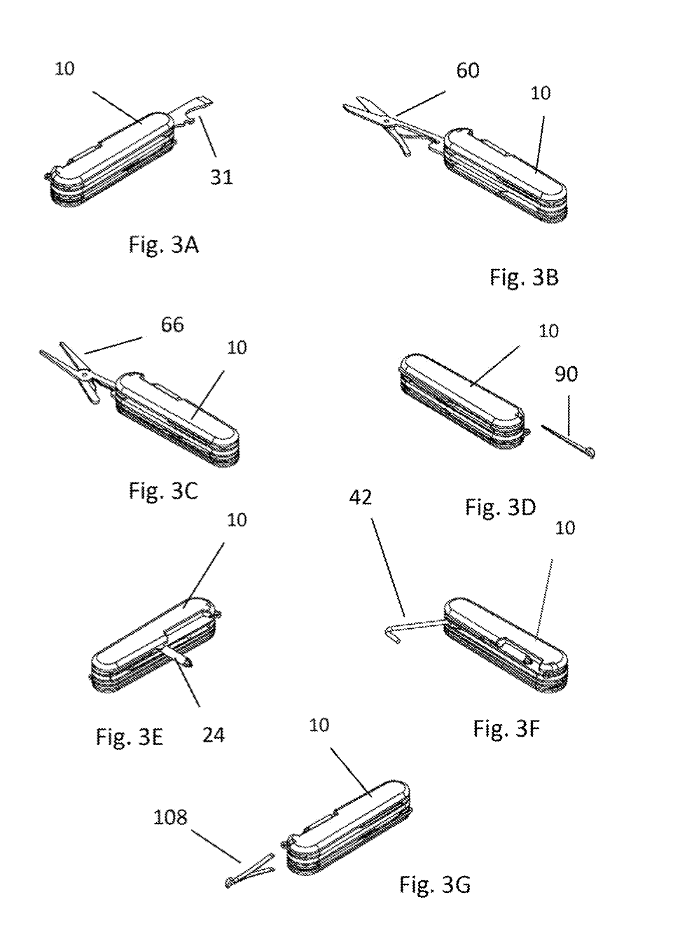

Referring to FIG. 3, there is shown multiple drawings A to G of the hockey tool 10 with various devices deployed. Figure A shows the deployment of device 31 which is a flat blade and bottle opener combination. Figure B shows the deployment of device 60 which is the scissor tool. Figure C shows the deployment of device 66 which is the pliers. Figure D shows deployment of device 90 which is the pick. Figure E shows deployment of device 24 which is the screw driver tool. Figure F shows deployment of device 42 which is the lace puller. Figure G shows deployment of device 108 which is the tweezers.

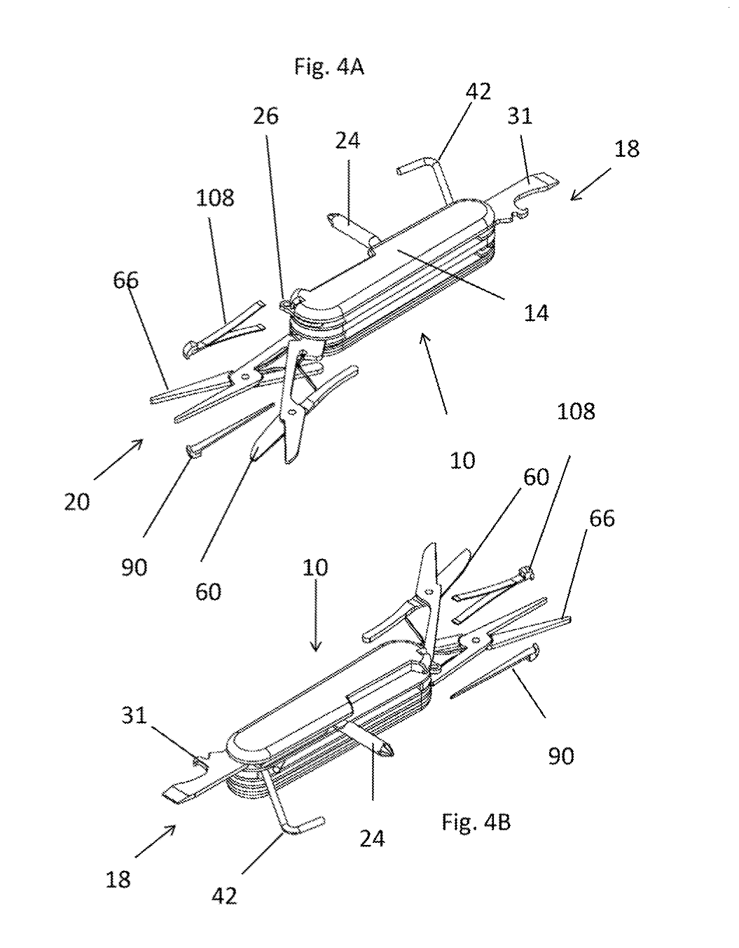

Referring to FIG. 4, and drawings 4A and 4B there is shown the tool 10 from two ends and top side 14. A variety of devices are shown deployed to show their relationship to one another. Viewing FIG. 4A, it is illustrated that devices 26, 60, 66, 90 and 108 deploy from the second end 20. Device 24 deploys from the centre of the tool. Devices 31 and 42 deploy from the first end 18 of the tool.

Our invention is a multi-purpose utility tool for hockey equipment comprising a handle comprising a handle first side piece and an opposite handle second side piece. The handle further comprises a handle first end, an opposite handle second end and a centre point. There is a plurality of devices pivotally attached to the tool by a plurality of pivot pins disposed between the handle first end and the opposite handle second end and between the handle first side piece and the opposite handle second side piece. These each have a device mounting end adapted for mounting on one of the pivot pins and a device working end for working on a work piece such as a skate. Each device working end has a storage position within said handle and disposed between the handle first side piece and the handle opposite handle second side piece. The device working end has a working position pivotally extended outwards from the handle. In one embodiment of the invention the tool comprises the following devices: a combination flat screw driving blade and bottle opener; a lace pulling tool; a lanyard mount; a scissor; a pliers; a screwing tool; a pick; and, tweezers.

While the preferred embodiments of our invention are described herein, various modifications may be made to our hockey tool and the appended claims are intended to cover all such modifications which may fall within the spirit and scope of our invention.

What is claimed is:

1. A multi-purpose utility tool for hockey equipment comprising:
a. a handle comprising a handle first side piece and an opposite handle second side piece;
b. said handle further comprising a handle first end, an opposite handle second end and a centre point;
c. a plurality of devices pivotally attached to said tool by a plurality of pivot pins disposed between said handle first end and said opposite handle second end and between said handle first side piece and said opposite handle second side piece;
d. wherein said plurality of devices each have a device mounting end adapted for mounting on one of said plurality of pivot pins and a device working end for working on a work piece; and,
e. further wherein said device working end has a storage position within said handle and disposed between the handle first side piece and the handle opposite handle second side piece; and
f. still further wherein the device working end has a working position pivotally extended outwards from the handle.

2. The tool of claim 1, wherein the plurality of devices includes a first device pivotally attached to the handle first end by a first pivot pin disposed between the handle first end and the handle second end proximate to the handle first end.

3. The tool of claim 2, wherein said first device is a combination flat screw driving blade and bottle opener.

4. The tool of claim 1, wherein the plurality of devices includes a second device pivotally attached to the handle by a second pivot pin disposed between the first pivot pin and the handle second end proximate to the first pivot pin.

5. The tool of claim 4, wherein said second device is a lace pulling tool.

6. The tool of claim 1, the plurality of devices includes a third device pivotally attached to the handle by a third pivot pin disposed between the handle first end and the handle second end proximate to the handle second end.

7. The tool of claim 6, wherein said third device is a lanyard mount.

8. The tool of claim 1, wherein the plurality of devices further includes a fourth device pivotally attached to said third pivot pin.

9. The tool of claim 8, wherein the fourth device is a scissor.

10. The tool of claim 1, wherein the plurality of devices further includes a fifth device pivotally attached to the third pivot pin.

11. The tool of claim 10, wherein said fifth device is a plier.

12. The tool of claim 1, wherein the plurality of devices further includes a sixth device pivotally mounted to a fourth pivot pin disposed between the handle first end and the handle second end proximate to said handle centre point.

13. The tool of claim 12, wherein said sixth device is a screwing tool.

14. The tool of claim 1, wherein the handle first side piece further comprises a top surface and a bottom surface, wherein said bottom surface includes a first channel disposed therein, said first channel exiting the bottom surface at a first notch in the handle first side piece second end, and wherein the first channel is adapted to receive a seventh device in a tight sliding relationship.

15. The tool of claim 14, wherein the seventh device is a pick.

16. The tool of claim 1, wherein the handle second side piece further comprises a top surface and a bottom surface, wherein said top surface includes a second channel disposed therein, said second channel exiting the top surface at a second notch in the handle second side piece second end, and wherein the second channel is adapted to receive an eighth device in a tight sliding relationship.

17. The tool of claim 16, wherein the eighth tool is tweezers.

18. The tool of claim 1, further comprising at least one separating plate disposed between adjacent devices of the plurality of devices, said separating plate comprising contours forming storage chambers for each device of the plurality of devices and permitting storage of said adjacent devices without interference and further permitting easy finger retrieval of each of said plurality of devices, and wherein the separating plate further includes at least one aperture for fitting over at least one of the plurality of pivot pins for flush alignment with the handle first side piece and the handle second side piece.

19. The tool of claim 1, wherein the plurality of pins include a fifth pin disposed between the third pin and the fourth pin proximate to the handle centre point, wherein said fifth pin, in combination with said first, second, third and fourth pins is adapted for aligning the at least one separating plate with the handle.

20. A multi-purpose utility tool for hockey equipment comprising:
a. a handle comprising a handle first side piece and an opposite handle second side piece;
b. said handle further comprising a handle first end, an opposite handle second end and a centre point;
c. a plurality of devices pivotally attached to said tool by a plurality of pivot pins disposed between said handle first end and said opposite handle second end and between said handle first side piece and said opposite handle second side piece;
d. wherein said plurality of devices each have a device mounting end adapted for mounting on one of said plurality of pivot pins and a device working end for working on a work piece; and,
e. further wherein said device working end has a storage position within said handle and disposed between the handle first side piece and the handle opposite handle second side piece; and
f. still further wherein the device working end has a working position pivotally extended outwards from the handle; and,
g. wherein said tool comprises the following devices:
i. a combination flat screw driving blade and bottle opener;
ii. a lace pulling tool;
iii. a lanyard mount;
iv. a scissor;
v. a plier;
vi. a screwing tool;
vii. a pick; and,
viii. tweezers.
